(19) United States
(12) Patent Application Publication
(10) Pub. No.: US 2021/0376409 A1
(43) Pub. Date: Dec. 2, 2021

(54) BATTERY COOLING AND FIRE PROTECTION SYSTEM AND METHOD OF OPERATING SAME

(71) Applicant: Global Graphene Group, Inc., Dayton, OH (US)

(72) Inventors: Aruna Zhamu, Springboro, OH (US); Bor Z. Jang, Centerville, OH (US)

(21) Appl. No.: 16/883,949

(22) Filed: May 26, 2020

(51) Int. Cl. H01M 10/6567; H01M 2/10; H01M 2/34; H01M 10/653; H01M 10/0525; H01M 10/054; H01M 10/06; H01M 10/39

(52) U.S. Cl. CPC H01M 10/6567; H01M 2/1077; H01M 2/348; H01M 10/3909; H01M 10/0525; H01M 10/054; H01M 10/06; H01M 10/653

(57) ABSTRACT

Provided is a battery cooling and fire protection system, comprising: (A) a plurality of battery cells, wherein at least a cell comprises an anode, a cathode, an electrolyte, a protective housing that at least partially encloses the anode, the cathode and the electrolyte, and at least one heat spreader element disposed partially or entirely inside the protective housing; and (B) a case configured to hold the plurality of battery cells and a cooling liquid, wherein the battery cells are partially or fully submerged in the cooling liquid, which is configured to be in thermal communication with the heat spreader element and is configured to transport heat generated by the battery cells through the heat spreader element to the cooling liquid and wherein the cooling liquid comprises a fire protection or fire suppression substance.

### BACKGROUND

Electric vehicles (EVs) are viewed as a promising solution to CO₂ emission and climate change issues. Batteries have been at the heart of the rapidly emerging EV industry. The service life, capacity, and internal resistance of various types of rechargeable batteries, particularly the lithium-ion battery, are sensitive to temperature changes.

One major problem is the danger of overheating, allowing a large amount of current to reach a location in an extremely short period of time, creating local hot spots that can significantly degrade or damage the various component materials (anode, cathode, separator, and electrolyte, etc.) of a battery cell. Under extreme conditions, the local heat may cause the liquid electrolyte of a battery to catch fire, leading to fire and explosion hazards. Battery life may be reduced by ⅔ in hot climates during aggressive driving and without cooling. With a battery temperature exceeding the stable point, severe exothermic reactions can occur uncontrollably. In addition, if a lithium-ion battery approaches thermal runaway, only 12% of the total heat released in the battery is enough to trigger thermal runaway in adjacent battery cells. This is the biggest risk during the use of lithium-ion batteries. In order not to compromise the service life of a battery, it is important to design a battery module with good heat dissipation performance.

More commonly used battery thermal management methods include air cooling, liquid cooling, and phase change material (PCM) cooling, Air cooling can meet the thermal management requirements of the vehicles under some ordinary conditions. However, when the EV accelerates or operates at a high velocity, the battery is discharged at a high rate, generating heat at a fast pace. Under these conditions, conventional air cooling is unable to meet the cooling requirements for electric vehicles.

Phase change material (PCM) cooling system controls the temperature of the battery module by the heat absorption and heat release when the material undergoes phase changes. Power battery cooling experiments using PCM are easier to meet the needs of the lithium battery cooling system, but the high costs have prevented more widespread use of PCMs in electric vehicles.

The liquid cooling system can exhibit higher cooling efficiency and reliability. The liquid cooling system requires good sealing and fluid pumping accessories. The cooling performance of lithium-ion pouch or prismatic cells may be improved with cold plates implemented along both surfaces of a cell and by changing the inlet coolant mass flow rates and the inlet coolant temperatures. The enhanced cooling energy efficiency can be achieved with a low inlet coolant temperature, low inlet coolant mass flow rate, and a high number of the cooling channels.

Numerous methods have been proposed to improve the cooling performance. For air or liquid cooling, for example, increasing the coolant velocity or the size of cooling structure may benefit the average temperature and temperature uniformity. However, such improvements increase the pack volume and weight, resulting in a larger power consumption of the battery thermal management system (BTMS).

Overheating or thermal runaway of a battery, leading to the battery catching fire or battery explosion, has been a serious barrier against the acceptance of battery-driven EVs. There has been no effective approach to overcoming this battery safety problem without adding significant weight, volume, and complexity of the thermal management system. An urgent need exists for a battery system that can be operated in a safe mode free from any thermal runaway problem.

### SUMMARY

An object of the present disclosure is to provide a cooling and fire protection system that enables the battery module/pack to operate in a safe mode with reduced or eliminated chance of overheating and without significantly increasing cooling system weight, volume, and complexity. Another object of this system is to have an ability to suppress fire immediately upon initiation. Yet another object of the disclosure is to provide a method of operating such a cooling and fire protection system and apparatus.

It may be noted that the word “electrode” herein refers to either an anode (negative electrode) or a cathode (positive electrode) of a battery. These definitions are also commonly accepted in the art of batteries or electrochemistry. In battery industry, a module comprises a plurality of battery cells packaged together. A pack comprises a plurality of modules aggregated together. The presently disclosed cooling and fire protection system can be used to cool and protect one or a plurality of battery cells, regardless if or not they are packed into a module or pack or simply some individual battery cells. The term “battery” can refer to a battery cell or several battery cells connected together.

The battery in the disclosure may be a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, or supercapacitor.

The present disclosure provides a battery cooling and fire protection system, comprising:
(a) a plurality of battery cells, wherein at least one of the battery cells comprises an anode, a cathode, an electrolyte disposed between the anode and the cathode, a protective housing that at least partially encloses the anode, the cathode and the electrolyte, and at least one heat spreader element disposed partially or entirely inside the protective housing; and
(b) a case configured to hold the plurality of battery cells and a cooling liquid, wherein the battery cells are partially or fully immersed in the cooling liquid and the cooling liquid is configured to be in thermal communication with the heat spreader element and is configured to transport heat generated by the battery cells (when the battery cells are discharged) through the heat spreader element to the cooling liquid and wherein the cooling liquid comprises a fire protection or fire suppression substance.

Preferably, the fire protection or fire suppression substance comprises a fluorinated organic compound. In certain embodiments, the fluorinated organic compound is selected from the group consisting of hydrochlorofluorocarbons, hydrofluorocarbons, perfluorocarbons, perfluorinated amines, partially fluorinated ethers, hydrofluoroethers, hydrofluorolefins, fluorinated ketones, and combinations thereof. In certain embodiments, the fluorinated organic compound is selected from those having a boiling point from 50 to 200° C., preferably from 65 to 150° C.

In some embodiments, the fluorinated organic compound is selected from a fluorinated ketone CₙF₂ₙO (6<n<20), heptafluoropropane, or a combination thereof.

In certain embodiments, the cooling liquid comprises a dielectric liquid having the fire protection or fire suppression substance dissolved or dispersed in the dielectric liquid. The fire protection or fire suppression substance may comprise ABC dry chemicals designed for extinguishing class A, class B, and/or class C fires.

It may be noted that monoammonium phosphate, ABC Dry Chemical, ABE Powder, tri-class, or multi-purpose dry chemical is a dry chemical extinguishing agent used on class A, class B, and class C fires. In this classification system, A for “Ash” (referring to ordinary solid combustibles), B for “Barrel” (Flammable liquids and gases), and C for “Current” (energized electrical equipment). It uses a specially fluidized and siliconized monoammonium phosphate powder. ABC dry chemical is usually a mix of monoammonium phosphate and ammonium sulfate, the former being the active one. The mix between the two agents is usually 40-60%, 60-40%, or 90-10% depending on local standards worldwide. The USGS uses a similar mixture, called Phos Chek G75F.

The heat spreader element or member (preferably in the form of a film, sheet, layer, belt, band, etc. of a highly conducting material such as graphene film or graphitic sheet) may be configured to be in thermal communication with the internal structure of a battery cell (e.g. to abut at least one of the anode and the cathode electrodes in the battery cell). The spreader element may be protruded out of a battery cell to make physical or thermal contact with the cooling liquid. Alternatively, the heat spreader element may be in physical contact with a tab (connecting pole or terminal) or cap of a battery cell and this tab or cap is in thermal contact with the cooling liquid (e.g. being submerged in the cooling liquid).

The case may have at least a first port and a second port configured to allow the cooling liquid to flow through the case with the battery cells being partially or fully submerged in the cooling liquid.

The cooling liquid may be in fluid communication with an external cooling device selected from a heat sink, a heat pipe, a vapor chamber, a stream of flowing fluid, a thermoelectric device, a heat exchanger, a radiator, or a combination thereof.

The heat spreader element preferably comprises a high thermal conductivity material having a thermal conductivity no less than 10 W/mK, preferably from 20 to 1,850 W/mK.

In certain embodiments, the heat spreader element comprises a material selected from a graphene film, flexible graphite sheet, artificial graphite film, Ag, Ag, Cu, Al, brass, steel, Ti, Ni, Mg alloy sheet, silicon nitride, boron nitride, aluminum nitride, boron arsenide, a composite thereof, or a combination thereof. The graphene film may contain a graphene selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

Inside the battery cell, the heat spreader element preferably is in physical or thermal contact with the anode or the cathode and has a heat-spreading area at least 50% (up to 100%) of a surface area of the anode or cathode.

If the heat spreader element comprises a thermal film, then the graphene film preferably has a thermal conductivity no less than 600 W/mK, more preferably no less than 1,000 W/mK, and most preferably from 1,500 to 1,850 W/mK. The heat spreader element preferably has a thickness from about 0.1 μm to about 1 mm. The heat spreader element preferably is in a heat-spreading relation to the anode or the cathode and draws heat therefrom during an operation of the battery cells.

In certain embodiments, the battery cell has an anode terminal and a cathode terminal for operating the battery and the heat spreader element is in thermal contact with the anode terminal or the cathode terminal wherein the anode terminal or the cathode terminal is configured to spread heat to the cooling liquid. The heat spreader element may be in thermal contact with the protective housing or a cap of the protective housing.

The disclosure also provides a method of cooling and protecting a battery module or pack comprising a plurality of battery cells. In certain embodiments, the method comprises holding the plurality of battery cells and a cooling liquid in a case, wherein the plurality of battery cells are partially or fully submerged in the cooling liquid that comprises a fire protection or fire suppression substance and wherein the cooling liquid remains stationary residing in the case or is circulated in and out of the case to carry the battery-generated heat away from the battery cells. This method may be applied to the operation of the aforementioned battery cooling and fire protection system.

In some embodiments, the method further comprises an operation of driving (e.g. pumping) or circulating the cooling liquid in and out of the case to carry any battery-generated heat away (e.g. by bringing the cooling liquid out of case to be in thermal contact with a cooling or heat-dissipating device or arrangement.

In some embodiments, the cooling liquid comprises a fluorinated organic compound selected from a hydrochlorofluorocarbon, hydrofluorocarbon, perfluorocarbon, perfluorinated amine, partially fluorinated ether, hydrofluoroether, hydrofluorolefin, fluorinated ketone (e.g. C₆F₁₂O, C₇F₁₄O, and CₙF₂ₙO, where n is an integer from 7 to 20), or a combination thereof.

In some embodiments, the cooling liquid comprises a fire protection or fire suppression substance dissolved or dispersed in a dielectric liquid having an electrical conductivity less than 10⁻¹⁰ S/cm. The cooling liquid preferably has a boiling point from 50° C. to 200° C.

In certain embodiments, in the disclosed method, at least a battery cell comprises a heat spreader element that is disposed inside an internal structure of the cell and is configured to draw heat therefrom and spread heat indirectly through a cell cap or tab or directly into the cooling liquid.

In the disclosed method, the heat spreader element has a thermal conductivity from 10 W/mK to 1,850 W/mK. Preferably, the heat spreader element comprises a graphene film containing a graphene material selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

In some embodiments, the heat spreader element comprises a material selected from graphene sheets, graphene foam, graphene-containing paste, graphene-containing polymer composite, flexible graphite sheet, artificial graphite film, particles of Ag, Ag, Cu, Al, brass, steel, Ti, Ni, Mg alloy, silicon nitride, boron nitride, aluminum nitride, boron arsenide, a composite thereof, or a combination thereof.

In some embodiments, the cooling liquid is in a thermal contact with a heat dissipating or cooling means or provision selected from a heat sink, a heat pipe, a vapor chamber, a stream of flowing fluid, a bath of a coolant fluid, a thermoelectric device, a cooled plate, a heat exchanger, a radiator, or a combination thereof.

In certain embodiments, the graphene film- or graphitic film-based heat spreader element has a thermal conductivity no less than 600 W/mK, preferably no less than 800 W/mK, further preferably no less than 1,000 W/mK, still further preferably no less than 1,200 W/mK, and most preferably no less than 1,500 W/mK (up to 1,800 W/mK).

The cooling liquid is designed to cool down a battery cell or multiple battery cells in a module or pack when the battery is discharged (e.g. when the cell(s) are operated to power an electronic device or EV motor). The heat generated by a cell is captured by the heat spreader element, which transports the heat to the cooling means. The cooling means is preferably selected from a heat sink, a heat pipe, a vapor chamber, a stream of flowing fluid (when an EV is in motion, air may be directed to flow into contact with the heat spreader tabs, for instance), a bath of a coolant fluid, a thermoelectric device, a cooled plate, a heat exchanger, a radiator, or a combination thereof.

In some embodiments, the heat-spreader element acts as a temperature sensor for measuring the surface temperature of the battery. For instance, a graphene sheet exhibits a resistance that varies with the surrounding temperature and, as such, a simple resistance measurement may be used to indicate the local temperature where the graphene sheet is disposed.

In the cooling and fire protection system, the case may be configured to form multiple loading sites (pores) for accommodating individual battery cells. In some embodiments, the lodging sites comprise cylindrical pores to accommodate cylindrical-shape battery cells or rectangular pores to accommodate rectangular-shape battery cells. There may be spaces between individual cells to accommodate the cooling liquid.

The cooling and protection liquid may be stationary (non-flowing) fluid residing in the case. Alternatively, the cooling liquid may be configured to flow into the case and flow out of the case, carrying heat away from the battery cells. The heat is then dissipated through a cooling means selected from a heat sink, a heat pipe, a vapor chamber, a stream of flowing fluid, a bath of a coolant fluid, a thermoelectric device, a cooled plate (cold plate), a heat exchanger, a radiator, or a combination thereof.

### BRIEF DESCRIPTION OF THE DRAWINGS

FIG. 1(A) Schematic of a rectangular battery cell in a battery cooling and fire protection system according to an embodiment of the present disclosure; a heat spreader element is protruded out of the battery cell to facilitate direct immersion in a cooling liquid;

FIG. 1(B) Schematic of a battery cooling and fire protection system according to another embodiment of the present disclosure; a heat spreader element is connected to a cap or tab of the battery cell, wherein the cap or tab is intended to be submerged in a cooling liquid.

FIG. 1(C) Schematic of a battery cooling and fire protection system that comprises multiple battery cells in a module, wherein the cells are partially or fully submerged in a cooling liquid.

FIG. 2(A) A diagram showing a procedure for producing graphene oxide sheets. These sheets can then be aggregated (e.g. roll-pressed) together or slurry-coated together, followed by a heat treatment procedure to produce graphene films.

FIG. 2(B) Schematic of a process for producing graphitic films from polymer or pitch films, according to certain embodiments of the disclosure.

FIG. 3 Thermal conductivity values of a series of graphitic films derived from graphene-PI films (66% graphene+34% PI), graphene paper alone, and PI film alone prepared at various final heat treatment temperatures.

FIG. 4(A) Schematic of a battery cooling and fire protection system according to another embodiment of the present disclosure; partially submerged in a cooling liquid.

FIG. 4(B) Schematic of a battery cooling and fire protection system according to another embodiment of the present disclosure; fully submerged in a cooling liquid.

### DETAILED DESCRIPTION OF PREFERRED EMBODIMENTS

The present discussion of preferred embodiments makes use of lithium-ion battery as an example. The present disclosure is applicable to a wide array of primary and secondary (rechargeable) batteries, not limited to the lithium-ion batteries. Examples of the rechargeable batteries include the lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, and supercapacitor.

Battery thermal management (BTM) systems can be divided into two groups: active BTM systems and passive BTM systems. An active BTM system dissipates the heat generated from batteries by circulating the cooling air or coolant around the batteries. This system generally needs a power-consuming device, such as a pump or a cooling fan, to circulate the cooling medium. An active BTM system is efficient in managing the battery temperature, but it consumes part of the battery energy and adds complexities to the system.

In contrast, a passive BTM system absorbs the heat generated from batteries by filling cooling materials with high specific heat (e.g. water/glycol mixture) in between batteries. A passive BTM system may also make use of a phase change material (PCM). Amongst the drawbacks of passive BTM systems is that the addition of the cooling material increases the weight of the battery system and reduces the volume of active charge storing material, thus reducing the specific energy of the battery system. Accordingly, there is a drive to use the minimum amount of cooling material to achieve the best cooling effect and minimal reduction in the specific energy of a secondary battery.

The present disclosure provides a battery cooling and fire protection system for a battery module (comprising one or a plurality of battery cells), which can be part of a passive or active BTM. In certain embodiments, the battery cooling and fire protection system comprises: (a) a plurality of battery cells, wherein at least one of the battery cells comprises an anode, a cathode, an electrolyte disposed between the anode and the cathode, a protective housing that at least partially encloses the anode, the cathode and the electrolyte, and at least one heat spreader element disposed partially or entirely inside the protective housing; and (b) a case configured to hold the plurality of battery cells and a cooling liquid, wherein the battery cells are partially or fully immersed in the cooling liquid and the cooling liquid is configured to be in thermal communication with the heat spreader element and is configured to transport heat generated by the battery cells (when the battery cells are discharged) through the heat spreader element to the cooling liquid and wherein the cooling liquid comprises a fire protection or fire suppression substance.

In a preferred embodiment, the heat spreader element comprises a graphene film, for instance. Due to the exceptionally high thermal conductivity of graphene (the highest among all materials known to scientists), such implementation of a graphene heat spreader member can rapidly transport the heat out of the battery cells, reducing or eliminating the need to have complex, bulky or heavy cooling apparatus. The disclosed cooling system per se can be a passive cooling system or part of an active cooling system.

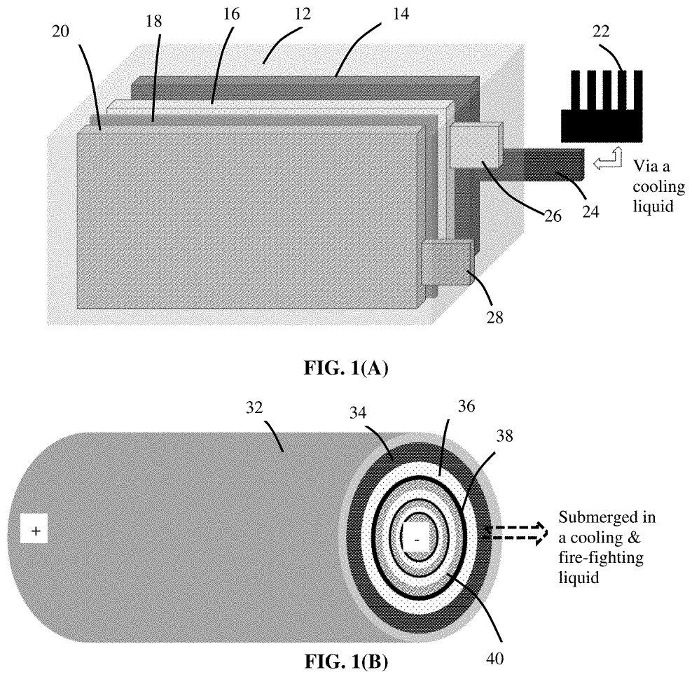

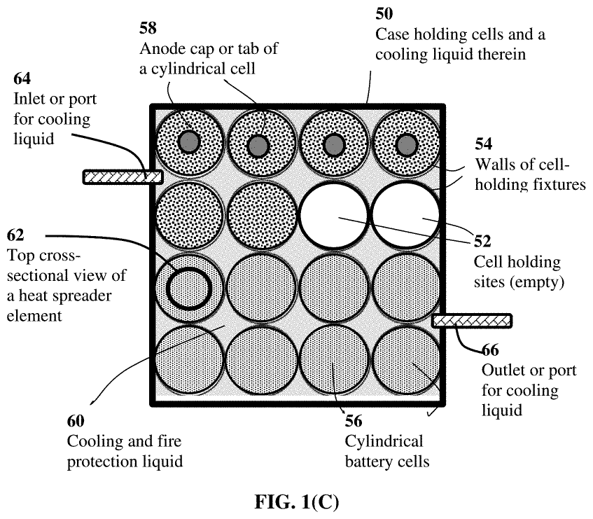

As illustrated in FIG. 1(A), according to some embodiments of the disclosure, the battery cooling and fire protection system comprises at least a battery cell submerged in a cooling liquid, which in turn is in thermal communication with an external cooling means (e.g. a heat sink, 22). The battery cell comprises an anode (negative electrode) 16, a cathode (positive electrode) 20, a separator 18 and electrolyte (not shown) disposed between the anode and the cathode, a casing or protective housing 12 that substantially encloses the above-listed components. Also enclosed is a heat spreader element 14, wherein the heat spreader element has a tab 24 protruded out of the battery cell housing 12 to be in direct contact with a cooling liquid. Also protruded out of the housing are a negative electrode terminal 26 connected to or integral with the anode 16 and a positive electrode terminal 28 connected to or integral with the cathode 20. The two electrode terminals are to be reversibly contacted with a battery charger (during battery charging) or a load (e.g. an electronic device, such as a smart phone, to be powered by the battery while discharging). It is the heat spreader element tab 24 that is immersed in a cooling liquid, which is in thermal or physical contact with the external cooling means (e.g. 22).

As illustrated in FIG. 1(B), according to another embodiment of the disclosure, the battery cell (a cylindrical cell) has a heat spreader element in thermal or physical contact with a cell cap, which is submerged in a cooling liquid. The battery cell comprises an anode 36, a cathode 40, a thin separator 38 and electrolyte (not shown) disposed between the anode and the cathode, a casing or protective housing 32 that substantially encloses the above-listed components. Also enclosed is a heat spreader element 34, which has one end in thermal contact with a housing cap (not shown); this cap, in combination with the housing 32, substantially seals the entire battery cell. This cap is, in turn, may be submerged in a cooling liquid. This cap may also serve as a terminal (e.g. negative terminal) for the battery cell; the positive terminal being located at the opposite end of this cylindrical cell. Alternatively, this cap may serve as a positive terminal and the opposite end is a negative terminal.

Illustrated in FIG. 1(C) is portion of a disclosed battery cooling and fire protection system, according to certain embodiments of the present disclosure. The system comprises a case 50 that holds multiple battery cells (e.g. 56) and a cooling liquid (60), which is also a fire protection liquid. The case has multiple cell-holding sites (e.g. 52), which may comprise cell-holding fixtures (e.g. 54). The cooling liquid 60 runs through the gaps between rows of battery cells. The cooling liquid may come in through a port 64 and exit through a port 66, which directs the cooling liquid to flow to make thermal communication with a cooling or heat-dissipating device, such as a heat sink or a radiator. The battery cells may have an end cap or tab (e.g. 58) that is submerged in the cooling liquid. Alternatively, the cell may have the heat spreader element (e.g. 62) protruding out of the battery cell to be submerged in the cooling liquid.

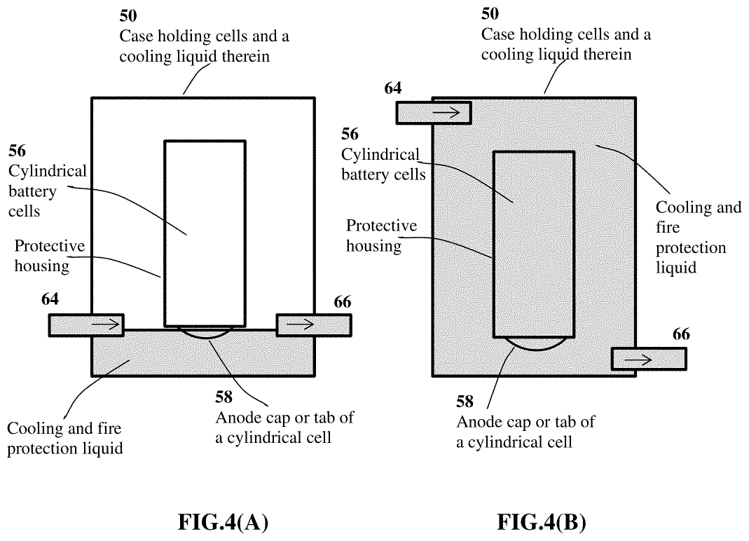

FIG. 4(A) shows an embodiment of the present disclosure in which the end cap 58 is submerged in the cooling liquid 60, and where the battery cells 56 are not completely submerged. FIG. 4(B) shows an embodiment in which the battery cells 56 are completely submerged in the cooling liquid 60. In FIG. 4(A) and FIG. 4(B) the end cap is in thermal communication with the enclosed battery cell, the enclosed battery cell may have an enclosed heat spreader in thermal contact with the end cap. FIG. 4(A) and FIG. 4(B) show round, curved end caps, but the geometry of the end caps may be any shape. The heat spreader enclosed in the protective housing may be in thermal contact with any cap, tab, end, or any section of the protective housing.

Heat generated from battery cells is transported through the heat spreader element into the cooling liquid. Due to the exceptionally high thermal conductivity of the graphene material (for instance), heat can rapidly spread from the internal structure of a battery cell to the graphene film-based heat spreader element, which conducts the heat out of the cell into the cooling liquid. The cooling liquid is preferably in thermal communication with a cooling means (e.g. a liquid coolant bath, a stream of flowing air, a heat pipe, a finned heat sink, a radiator, etc.). Heat is then dissipated or removed by the cooling means.

There is no limitation on the type of cooling means that can be implemented to cool down the cooling liquid, which in turn cools down the battery cells when working to power an electronic device or an EV. Again, the cooling means may be selected from a heat sink, a heat pipe, a vapor chamber, a stream of flowing fluid, a thermoelectric device, a cooled/refrigerated plate, a heat exchanger, a radiator, or a combination thereof.

It is important that the heat spreader element has a high thermal conductivity to allow for rapid transfer of a large amount of heat from the battery cells through the heat spreader element and a cooling liquid to a cooling means when the cell is discharged.

In certain embodiments, the heat-spreader element comprises a high thermal conductivity material having a thermal conductivity no less than 10 W/mK (preferably no less than 200 W/mK, further preferably greater than 600 W/mK, more preferably greater than 1,000 W/mK, and most preferably greater than 1,500 W/mK). Preferably, the heat spreader element comprises a material selected from graphene film (e.g. composed of graphene sheets aggregated together or bonded together into a film or sheet form, typically having a thermal conductivity from 800 W/mK to 1,850 W/mK and a thickness from 10 nm to 5 mm) or graphene-reinforced composite.

The heat spreader element may comprise a material selected from graphene sheets, graphene foam, graphene-containing paste, graphene-containing polymer composite, flexible graphite sheet, artificial graphite film (e.g. produced from carbonization and graphitization of a polymer film or pitch film), particles of Ag, Ag, Cu, Al, brass, steel, Ti, Ni, Mg alloy, silicon nitride, boron nitride, aluminum nitride, boron arsenide, a composite thereof, or a combination thereof.

The graphene film contains a graphene selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof. The graphene film typically exhibits a thermal conductivity from 800 to 1,850 W/mK. Flexible graphite sheet typically exhibits a thermal conductivity from 150 to 600 W/mK. Artificial graphite films (e.g. those produced by carbonizing and graphitizing a polymer film) can exhibit a thermal conductivity from 600 to 1,700 W/mK. Graphene films, flexible graphite sheets, and artificial graphite films are commonly regarded as three distinct classes of materials.

In some embodiments, the battery cooling system further comprises at least a temperature sensor for measuring the surface temperature of the battery cells. In some embodiments, the heat-spreader element acts as a temperature sensor for measuring an internal temperature of the battery. For instance, the graphene sheet exhibits a resistance that varies with the surrounding temperature and, as such, a simple resistance measurement may be used to indicate the local temperature where the graphene sheet is disposed.

Another important ingredient in the presently disclosed battery cooling and fire protection system is the cooling liquid, which itself is a fire protection or fire suppression material or contains a fire protection or fire suppression material. When or if a battery cell catches a fire (e.g. due to thermal runaway caused by lithium dendrite formation, cell overcharging or fast discharging, etc.), the fire would be immediately suppressed since the cell is partially or fully submerged in this cooling and fire protection liquid. This liquid plays a dual role of keeping the battery cells to operate at a safe temperature and to suppress any fire immediately without allowing the fire to spread over to other battery cells or to cause explosion.

Preferably, the fire protection or fire suppression substance comprises a fluorinated organic compound. In certain embodiments, the fluorinated organic compound is selected from the group consisting of hydrochlorofluorocarbons, hydrofluorocarbons, perfluorocarbons, perfluorinated amines, partially fluorinated ethers, hydrofluoroethers, hydrofluorolefins, fluorinated ketones (e.g. C₆F₁₂O, C₇F₁₄O, and CₙF₂ₙO, where n is an integer from 8 to 20), and combinations thereof. In addition to CₙF₂ₙO (n>6), heptafluoropropane is a useful compound. In certain embodiments, the fluorinated organic compound is selected from those having a boiling point from 50 to 200° C., preferably from 65 to 150° C.

In certain embodiments, the cooling liquid comprises a dielectric liquid having the fire protection or fire suppression substance dissolved or dispersed in the dielectric liquid. The fire protection or fire suppression substance may comprise ABC dry chemicals designed for extinguishing class A, class B, and/or class C fires.

It may be noted that monoammonium phosphate, ABC Dry Chemical, ABE Powder, tri-class, or multi-purpose dry chemical is a dry chemical extinguishing agent used on class A, class B, and class C fires. In this classification system, A for “Ash” (referring to ordinary solid combustibles), B for “Barrel” (Flammable liquids and gases), and C for “Current” (energized electrical equipment). It uses a specially fluidized and siliconized monoammonium phosphate powder. ABC dry chemical is usually a mix of monoammonium phosphate and ammonium sulfate, the former being the active one. The mix between the two agents is usually 40-60%, 60-40%, or 90-10% depending on local standards worldwide. The USGS uses a similar mixture, called Phos Chek G75F.

Lithium-ion batteries are subject to a catastrophic failure mode known as thermal runaway under certain conditions. Thermal runaway is a series of internal exothermic reactions that can be caused by electrical overcharge, overheating, or from an internal electrical short. The internal shorts are typically caused by manufacturing defects or impurities, dendritic lithium formation and mechanical damage. In any of these failure conditions, the battery is unable to contain its electrochemical energy resulting in high, localized temperatures and rapid release of energy. In an unprotected standard air atmosphere this high-energy event can increase the temperature of adjacent cells creating a cell-to-cell cascading thermal runaway event that is significantly more energetic than the initial event. By having the battery packs immersed in a presently disclosed cooling and fire protection liquid, cell-to-cell cascading thermal runaway can be entirely avoided.

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In other words, graphene planes (hexagonal lattice structure of carbon atoms) constitute a significant portion of a graphite particle.

A single-layer graphene sheet is composed of carbon atoms occupying a two-dimensional hexagonal lattice. Multi-layer graphene is a platelet composed of more than one graphene plane. Individual single-layer graphene sheets and multi-layer graphene platelets are herein collectively called nano graphene platelets (NGPs) or graphene materials. NGPs include pristine graphene (essentially 99% of carbon atoms), slightly oxidized graphene (<5% by weight of oxygen), graphene oxide (≥5% by weight of oxygen), slightly fluorinated graphene (<5% by weight of fluorine), graphene fluoride ((≥5% by weight of fluorine), other halogenated graphene, and chemically functionalized graphene.

Our research group was among the first to discover graphene [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. The processes for producing NGPs and NGP nanocomposites were recently reviewed by us [Bor Z. Jang and A Zhamu, “Processing of Nano Graphene Platelets (NGPs) and NGP Nanocomposites: A Review,” J. Materials Sci. 43 (2008) 5092-5101]. The production of various types of graphene sheets is well-known in the art.

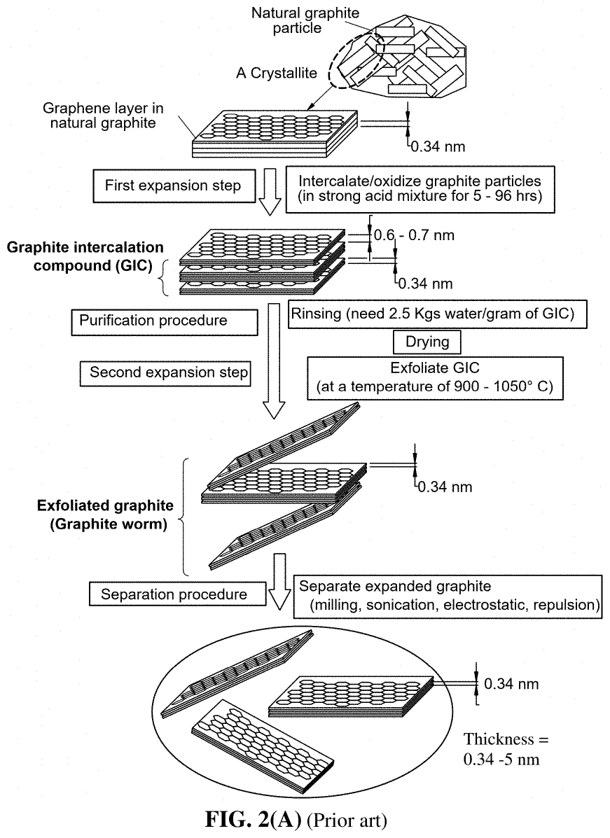

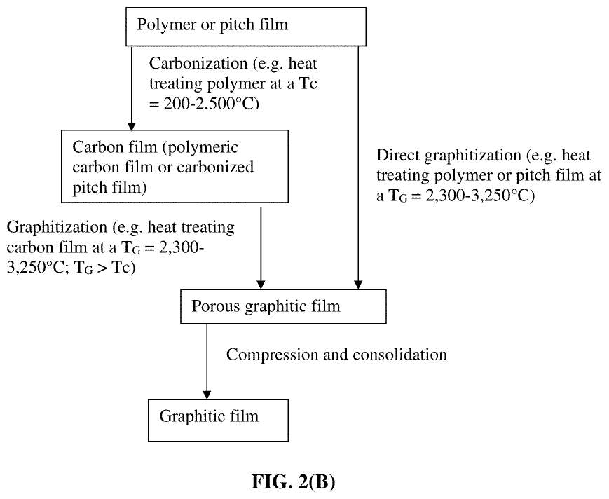

For instance, as shown in FIG. 2(A), the chemical processes for producing graphene sheets or platelets typically involve immersing powder of graphite or other graphitic material in a mixture of concentrated sulfuric acid, nitric acid, and an oxidizer, such as potassium permanganate or sodium perchlorate, forming a reacting mass that requires typically 5-120 hours to complete the chemical intercalation/oxidation reaction. Once the reaction is completed, the slurry is subjected to repeated steps of rinsing and washing with water. The purified product is commonly referred to as graphite intercalation compound (GIC) or graphite oxide (GO). The suspension containing GIC or GO in water may be subjected to ultrasonication to produce isolated/separated graphene oxide sheets dispersed in water. The resulting products are typically highly oxidized graphene (i.e. graphene oxide with a high oxygen content), which must be chemically or thermal reduced to obtain reduced graphene oxide (RGO).

Alternatively, the GIC suspension may be subjected to drying treatments to remove water. The dried powder is then subjected to a thermal shock treatment. This can be accomplished by placing GIC in a furnace pre-set at a temperature of typically 800-1100° C. (more typically 950-1050° C.) to produce exfoliated graphite (or graphite worms), which may be subjected to a high shear or ultrasonication treatment to produce isolated graphene sheets.

Alternatively, graphite worms may be re-compressed into a film form to obtain a flexible graphite sheet, which is a fundamentally distinct material than graphene film. Flexible graphite sheet has a thermal conductivity from 100 to 500 W/mK and, in contrast, graphene film has a thermal conductivity from 800 to 1,800 W/mK. Flexible graphite sheets are commercially available from many sources worldwide.

The starting graphitic material may be selected from natural graphite, synthetic graphite, highly oriented pyrolytic graphite, graphite fiber, graphitic nano-fiber, graphite fluoride, chemically modified graphite, meso-carbon micro-bead, partially crystalline graphite, or a combination thereof.

Pristine graphene sheets may be produced by the well-known liquid phase exfoliation or metal-catalyzed chemical vapor deposition (CVD).

The highly oriented graphene film (HOGF), as a heat spreader element, may be produced from graphene oxide, graphene fluoride, etc. There is no theoretical limit on the thickness of the HOGF that can be produced using the presently invented process. As an example, the process for producing a graphene thermal film (for use as a graphene heat spreader element) includes:

(a) preparing either a graphene oxide dispersion (GO suspension) having graphene oxide sheets dispersed in a fluid medium or a GO gels having GO molecules dissolved in a fluid medium, wherein the GO sheets or GO molecules contain an oxygen content higher than 5% by weight (typically higher than 10%, more typically higher than 20%, often higher than 30%, and can be up to approximately 50% by weight);

(b) dispensing and depositing the GO dispersion or GO gel onto a surface of a supporting solid substrate to form a layer of graphene oxide (wet layer) having a (wet) thickness preferably less than 10 mm (preferably less than 2.0 mm, more preferably less than 1 mm, and most preferably less than 0.5 mm), wherein the dispensing and depositing procedure (e.g. coating or casting) includes subjecting the graphene oxide dispersion to an orientation-inducing stress;

(c) partially or completely removing the fluid medium from the wet layer of graphene oxide to form a dried layer of graphene oxide having a dried layer thickness less than 2 mm and having an inter-plane spacing d₀₀₂ of 0.4 nm to 1.2 nm as determined by X-ray diffraction and an oxygen content no less than 5% by weight; and

(d) heat treating the layer of dried graphene oxide under an optional compressive stress to produce the highly oriented graphene film at a heat treatment temperature higher than 100° C. (typically from 500° C. to 3,200° C.) to an extent that an inter-plane spacing d₀₀₂ is decreased to a value less than 0.4 nm and the oxygen content is decreased to less than 5% by weight. The resulting graphene film may be further compressed to reduce the thickness and increase the physical density of the film. The desired physical density of the graphene film is from 1.7 g/cm³ to 2.25 g/cm³.

In one embodiment, wherein the heat treatment temperature contains a temperature in the range from 500° C.-1,500° C., the resulting highly oriented graphene film structure has an oxygen content less than 1%, an inter-graphene spacing less than 0.345 nm, a thermal conductivity of at least 1,000 W/mK, and/or an electrical conductivity no less than 3,000 S/cm.

In another embodiment, wherein the heat treatment temperature contains a temperature in the range from 1,500° C.-2,100° C., the highly oriented graphene film structure has an oxygen content less than 0.01%, an inter-graphene spacing less than 0.337 nm, a thermal conductivity of at least 1,300 W/mK, and/or an electrical conductivity no less than 5,000 S/cm.

In a preferred embodiment, wherein the heat treatment temperature contains a temperature greater than 2,100° C., the highly oriented graphene structure has an oxygen content no greater than 0.001%, an inter-graphene spacing less than 0.336 nm, a mosaic spread value no greater than 0.7, a thermal conductivity of at least 1,500 W/mK, and/or an electrical conductivity no less than 10,000 S/cm.

In another preferred embodiment, wherein the heat treatment temperature contains a temperature no less than 2,500° C., the highly oriented graphene film structure has an inter-graphene spacing less than 0.336 nm, a mosaic spread value no greater than 0.4, a thermal conductivity greater than 1,600 W/mK, and/or an electrical conductivity greater than 10,000 S/cm.

Typically, the highly oriented graphene film structure exhibits an inter-graphene spacing less than 0.337 nm and a mosaic spread value less than 1.0. More typically, the highly oriented graphene structure exhibits a degree of graphitization no less than 80% (preferably and more typically no less than 90%) and/or a mosaic spread value less than 0.4.

Due to the notion that highly aligned GO sheets or GO molecules can be chemically merged together in an edge-to-edge manner, the resulting highly oriented graphene structure has a grain size that is significantly larger than the maximum grain size of the starting graphitic material prior to or during oxidation of the graphitic material. In other words, if the graphene oxide dispersion is obtained from a graphitic material having a maximum original graphite grain size, then the resulting highly oriented graphene structure is normally a single crystal or a poly-crystal graphene structure having a grain size larger than this maximum original grain size.

Internal structure-wise, the highly oriented graphene structure contains chemically bonded graphene planes that are parallel to one another. The graphene oxide dispersion is typically obtained from a graphitic material having multiple graphite crystallites exhibiting no preferred crystalline orientation as determined by an X-ray diffraction or electron diffraction method. However, the highly oriented graphene structure is typically a single crystal or a poly-crystal graphene structure having a preferred crystalline orientation as determined by said X-ray diffraction or electron diffraction method. In some cases, the highly oriented graphene structure contains a combination of sp² and sp³ electronic configurations. In the invented process, the step of heat-treating induces chemical linking, merging, or chemical bonding of graphene oxide molecules, and/or re-graphitization or re-organization of a graphitic structure.

In addition to graphene films, another preferred class of thermal films for use as a heat spreader element is the pyrolytic graphite film (also referred to as the graphitic film or artificial graphite film) that is prepared from the carbonization and graphitization of polymer films or pitch films.

For instance, as schematically illustrated in FIG. 2(B), the process begins with carbonizing a polymer film at a carbonization temperature of 200-2,500° C. (more typically 400-1,500° C.) under a typical pressure of 10-15 Kg/cm² for 2-10 hours to obtain a carbonized material, which is followed by a graphitization treatment at 2,500-3,200° C. under an ultrahigh pressure of 100-300 Kg/cm² for 1-5 hours to form a graphitic film. The carbon precursor polymer may be preferably selected from the group consisting of polyimide, polyamide, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, phenolic resin, composites thereof (containing graphene sheets and/or graphite flakes dispersed in the carbon precursor film), and combinations thereof. These polymers are found to have a high carbon yield when they are carbonized and/or graphitized.

An example of this process is disclosed in Y. Nishikawa, et al. “Filmy graphite and process for producing the same,” U.S. Pat. No. 7,758,842 (Jul. 20, 2010) and in Y. Nishikawa, et al. “Process for producing graphite film,” U.S. Pat. No. 8,105,565 (Jan. 31, 2012).

The rechargeable battery that can take advantage of the presently disclosed cooling system may be a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, or supercapacitor.

The disclosure also provides a method of cooling and protecting a battery module or pack comprising a plurality of battery cells. In certain embodiments, the method comprises holding the plurality of battery cells and a cooling liquid in a case, wherein the plurality of battery cells are partially or fully submerged in the cooling liquid that comprises a fire protection or fire suppression substance and wherein the cooling liquid remains stationary residing in the case or is circulated in and out of the case to carry the battery-generated heat away from the battery cells. This method may be applied to the operation of the aforementioned battery cooling and fire protection system.

Preferably, the method further comprises an operation of driving (e.g. pumping) or circulating the cooling liquid in and out of the case to carry any battery-generated heat away (e.g. by bringing the cooling liquid out of case to be in thermal contact with a cooling or heat-dissipating device or arrangement. The cooling means (device or arrangement) may be a heat sink, a heat pipe, a vapor chamber, a stream of flowing fluid (when an EV is in motion, air may be directed to flow into contact with the heat spreader tabs, for instance), a bath of a coolant fluid, a thermoelectric device, a cooled plate, a heat exchanger, a radiator, or a combination thereof.

In some embodiments, the cooling liquid is or comprises a fluorinated organic compound selected from a hydrochlorofluorocarbon, hydrofluorocarbon, perfluorocarbon, perfluorinated amine, partially fluorinated ether, hydrofluoroether, hydrofluorolefin, fluorinated ketone (e.g. C₆F₁₂O, C₇F₁₄O, and, in general, CₙF₂ₙO, where n is an integer from 6 to 20), or a combination thereof. The chemical C₆F₁₂O (where n=6) has a boiling point of 49° C. will make handling an organic vapor challenging when the battery cells (e.g. in an electric vehicle) are in full operation or exposed to sunshine in a hot summer day. The cell temperature can reach 65° C., sometimes >75° C. or even 85° C. Hence, a cooling liquid preferably has a boiling point from 50° C. to 200° C., more preferably >65° C. (e.g. CₙF₂ₙO with n>6), further preferably >75° C. (e.g. CₙF₂ₙO with n>7), and still more preferably >85° C. (e.g. CₙF₂ₙO with n>8).

In some embodiments, the cooling liquid comprises a fire protection or fire suppression substance dissolved or dispersed in a dielectric liquid having an electrical conductivity less than 10⁻¹⁰ S/cm. The cooling liquid can contain water provided the fire protection or suppression chemical is compatible with water.

In certain embodiments, in the disclosed method, at least a battery cell comprises a heat spreader element that is disposed inside an internal structure of the cell and is configured to draw heat therefrom and spread heat indirectly through a cell cap or tab or directly into the cooling liquid. The heat spreader element preferably has a thermal conductivity from 10 W/mK to 1,850 W/mK. Preferably, the heat spreader element comprises a graphene film containing a graphene material selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

The heat spreader element may comprise a material selected from graphene sheets, graphene foam, graphene-containing paste, graphene-containing polymer composite, flexible graphite sheet, artificial graphite film, particles of Ag, Ag, Cu, Al, brass, steel, Ti, Ni, Mg alloy, silicon nitride, boron nitride, aluminum nitride, boron arsenide, a composite thereof, or a combination thereof. The graphene film- or graphitic film-based heat spreader element preferably has a thermal conductivity no less than 600 W/mK, preferably no less than 800 W/mK, further preferably no less than 1,000 W/mK, still further preferably no less than 1,200 W/mK, and most preferably no less than 1,500 W/mK (up to 1,800 W/mK).

The cooling liquid is preferably in a thermal contact with a heat dissipating or cooling means or provision selected from a heat sink, a heat pipe, a vapor chamber, a stream of flowing fluid, a bath of a coolant fluid, a thermoelectric device, a cooled plate, a heat exchanger, a radiator, or a combination thereof.

The cooling liquid is designed to cool down a battery cell or multiple battery cells in a module or pack when the battery is discharged (e.g. when the cell(s) are operated to power an electronic device or EV motor) or charged. The heat generated by a cell is captured by the heat spreader element, which transports the heat to the cooling liquid which preferably in turn makes thermal contact with a heat dissipating or cooling means or provision. The heat dissipating or cooling means or provision is preferably selected from a heat sink, a heat pipe, a vapor chamber, a stream of flowing fluid (when an EV is in motion, air may be directed to flow into contact with the heat spreader tabs, for instance), a bath of a coolant fluid, a thermoelectric device, a cooled plate, a heat exchanger, a radiator, or a combination thereof.

In the cooling and fire protection system, the case may be configured to form multiple loading sites (pores) for accommodating individual battery cells. In some embodiments, the lodging sites comprise cylindrical pores to accommodate cylindrical-shape battery cells or rectangular pores to accommodate rectangular-shape battery cells. There may be spaces between individual cells to accommodate the cooling liquid.

The cooling and protection liquid may be a stationary (non-flowing) fluid residing in the case. Alternatively, the cooling liquid may be configured to flow into the case and flow out of the case, carrying heat away from the battery cells. The heat is then dissipated through a heat-dissipating or cooling means or provision.

The following examples serve to provide the best modes of practice for the present disclosure and should not be construed as limiting the scope of the disclosure:

### EXAMPLE 1

### Preparation of Single-Layer Graphene Sheets and their Heat-Spreader Films from Meso-Carbon Micro-Beads (MCMBs)

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMB s were repeatedly washed in a 5% solution of HCl to remove most of the sulfate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

The GO sheets contain oxygen proportion of approximately 35%-47% by weight for oxidation treatment times of 48-96 hours. GO sheets were suspended in water. The GO suspension was cast into thin graphene oxide films on a glass surface and, separately, was also slot die-coated onto a PET film substrate, dried, and peeled off from the PET substrate to form GO films. The GO films were separately heated from room temperature to 2,500° C. and then roll-pressed to obtain reduced graphene oxide (RGO) films for use as a heat spreader. The thermal conductivity of these films was found to be from 1,225 to 1,750 W/mK using Neize heat conductivity measuring device.

### EXAMPLE 2

### Preparation of Pristine Graphene Sheets (0% Oxygen) and Heat Spreader Films

Pristine graphene sheets were produced by using the direct ultrasonication or liquid-phase production process. In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson 5450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements.

The pristine graphene sheets were immersed into a 10 mM acetone solution of BPO for 30 min and were then taken out drying naturally in air. The heat-initiated chemical reaction to functionalize graphene sheets was conducted at 80° C. in a high-pressure stainless steel container filled with pure nitrogen. Subsequently, the samples were rinsed thoroughly in acetone to remove BPO residues for subsequent Raman characterization. As the reaction time increased, the characteristic disorder-induced D band around 1330 cm⁻¹ emerged and gradually became the most prominent feature of the Raman spectra. The D-band is originated from the A_{1g} mode breathing vibrations of six-membered sp² carbon rings, and becomes Raman active after neighboring sp² carbon atoms are converted to sp³ hybridization. In addition, the double resonance 2D band around 2670 cm⁻¹ became significantly weakened, while the G band around 1580 cm⁻¹ was broadened due to the presence of a defect-induced D′ shoulder peak at ˜1620 cm⁻¹. These observations suggest that covalent C-C bonds were formed and thus a degree of structural disorder was generated by the transformation from sp² to sp³ configuration due to reaction with BPO.

The functionalized graphene sheets were re-dispersed in water to produce a graphene dispersion. The dispersion was then made into graphene films using comma coating and subjected to heat treatments up to 2,500° C. The heat spreader films obtained from functionalized graphene sheets exhibit a thermal conductivity from 1,450 to 1,750 W/mK.

On a separate basis, non-functionalized pristine graphene powder was directly compressed into graphene films (aggregates of graphene sheets) using pairs of steel rollers; no subsequent heat treatment was conducted. These graphene films exhibit a thermal conductivity typically from approximately 600 to about 1,000 W/mK.

### EXAMPLE 3

### Preparation of Graphene Fluoride Sheets and Heat Spreader Films

Several processes have been used by us to produce GF, but only one process is herein described as an example. In a typical procedure, highly exfoliated graphite (HEG) was prepared from intercalated compound C₂F·ₓClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Five minutes of sonication was enough to obtain a relatively homogenous dispersion, but a longer sonication time ensured better stability. Upon extrusion to form wet films on a glass surface with the solvent removed, the dispersion became brownish films formed on the glass surface. The dried films, upon drying and roll-pressing, became heat spreader films having a reasonably good thermal conductor (thermal conductivity from 250 to 750 W/mK), yet an electrical insulator. The unique combination of electrical insulation and thermal conduction characteristics is of particular interest for battery heating configurations wherein there is no concern of any potential negative effect cause by an electrical conductor.

### EXAMPLE 4

### Preparation of Nitrogenated Graphene Sheets and Graphene Films for use as a Heat Spreader Element

Graphene oxide (GO), synthesized in Example 1, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene/urea mass ratios of 1/0.5, 1/1 and 1/2 have the nitrogen contents of 14.7, 18.2 and 17.5 wt. %, respectively, as found by elemental analysis. These nitrogenated graphene sheets, without prior chemical functionalization, remain dispersible in water. The resulting suspensions were then coated and made into wet films and then dried. The dried films were roll-pressed to obtain graphene films, having a thermal conductivity from 350 to 820 W/mK. These films are also electrical insulators.

Some of these films were subjected to heat treatments at 300° C. for 2 hours and then at 2,800° C. for 2 hours. The resulting graphene films show a thermal conductivity from 1,200 to 1,700 W/mK.

### EXAMPLE 5

### Fluorination of Graphite to Produce Exfoliated Graphite and Flexible Graphene Sheets

Natural graphite flakes, a sieve size of 200 to 250 mesh, were heated in vacuum (under less than 10⁻² mmHg) for about 2 hours to remove the residual moisture contained in the graphite. Fluorine gas was introduced into a reactor and the reaction was allowed to proceed at 375° C. for 120 hours while maintaining the fluorine pressure at 200 mmHg. This was based on the procedure suggested by Watanabe, et al. disclosed in U.S. Pat. No. 4,139,474. The powder product obtained was black in color. The fluorine content of the product was measured as follows: The product was burnt according to the oxygen flask combustion method and the fluorine was absorbed into water as hydrogen fluoride. The amount of fluorine was determined by employing a fluorine ion electrode. From the result, we obtained a GF (Sample 5A) having an empirical formula (CF_{0.75})ₙ. X-ray diffraction indicated a major (002) peak at 2θ=13.5 degrees, corresponding to an inter-planar spacing of 6.25 Å. Some of the graphite fluoride powder was thermally exfoliated to form graphite worms, which were air jet-milled to obtain expanded graphite flakes. The expanded graphite flakes were then compressed into graphitic sheets.

### EXAMPLE 6

### Preparation of Polybenzoxazole (PBO) Films, Graphene-PBO Films, and Expanded Graphite Flake-PBO Films (Followed by Carbonization/Graphitization to Produce Pyrolytic Films)

Polybenzoxazole (PBO) films were prepared via casting and thermal conversion from its precursor, methoxy-containing polyaramide (MeO-PA). Specifically, monomers of 4, 4′-diamino-3,3′-dimethoxydiphenyl (DMOBPA), and isophthaloyl dichloride (IPC) were selected to synthesize PBO precursors, methoxy-containing polyaramide (MeO-PA) solution. This MeO-PA solution for casting was prepared by polycondensation of DMOBPA and IPC in DMAc solution in the presence of pyridine and LiCl at −5° C. for 2 hr, yielding a 20 wt % pale yellow transparent MeO-PA solution. The inherent viscosity of the resultant MeO-PA solution was 1.20 dL/g measured at a concentration of 0.50 g/dl at 25° C. This MeO-PA solution was diluted to a concentration of 15 wt % by DMAc for casting.

The as-synthesized MeO-PA was cast onto a glass surface to form thin films (35-120 μm) under a shearing condition. The cast film was dried in a vacuum oven at 100° C. for 4 hr to remove the residual solvent. Then, the resulting film with thickness of approximately 28-100 μm was treated at 200° C.-350° C. under N₂ atmosphere in three steps and annealed for about 2 hr at each step. This heat treatment serves to thermally convert MeO-PA into PBO films. For comparison, both graphene-PBO and expanded graphite flake-PBO films were made under similar conditions. The graphene or EP flake proportions were varied from 10% to 90% by weight.

All the films prepared were pressed between two plates of alumina while being heat-treated (carbonized) under a 3-sccm argon gas flow in three steps: from room temperature to 600° C. in 1 h, from 600 to 1,000° C. in 1.5 h, and maintained at 1,000° C. for 1 h. The carbonized films were then roll-pressed in a pair of rollers to reduce the thickness by approximately 40%. The roll-pressed films were then subjected to graphitization treatments at 2,200° C. for 5 hours, followed by another round of roll-pressing to reduce the thickness by typically 20-40%. The thermal conductivity values of a series of graphitic films derived from graphene-PBO films of various graphene weight fractions (from 0% to 100%) were measured. Significantly and unexpectedly, some thermal conductivity values are higher than those of both the film derived from PBO alone (860 W/mK) and the graphene paper derived from graphene sheets alone (645 W/mK). Quite interestingly, the neat PBO-derived graphitic films prepared under identical conditions exhibit a highest conductivity value of 860 W/mK, yet several combined graphene-PBO films, when carbonized and graphitized, exhibit thermal conductivity values of 924-1,145 W/mK.

The thermal conductivity values of a series of graphitic films derived from EP-PBO films of various weight fractions of expanded graphite flakes (EP, from 0% to 100%) were also obtained.

### EXAMPLE 7

### Preparation of Polyimide (PI) Films, Graphene-PI Films, and the Heat Treated Versions Thereof

The synthesis of conventional polyimide (PI) involved poly(amic acid) (PAA, Sigma Aldrich) formed from pyromellitic dianhydride (PMDA) and oxydianiline (ODA). Prior to use, both chemicals were dried in a vacuum oven at room temperature. Next, 4 g of the monomer ODA was dissolved into 21 g of DMF solution (99.8 wt %). This solution was stored at 5° C. before use. PMDA (4.4 g) was added, and the mixture was stirred for 30 min using a magnetic bar. Subsequently, the clear and viscous polymer solution was separated into four samples. Triethyl amine catalyst (TEA, Sigma Aldrich) with 0, 1, 3, and 5 wt % was then added into each sample to control the molecular weight. Stirring was maintained by a mechanical stirrer until the entire quantity of TEA was added. The as-synthesized PAA was kept at −5° C. to maintain properties essential for further processing.

Solvents utilized in the poly(amic acid) synthesis play a very important role. Common dipolar aprotic amide solvents utilized are DMF, DMAc, NMP and TMU. DMAc was utilized in the present study. The intermediate poly(amic acid) and NGP-PAA precursor composite were converted to the final polyimide by the thermal imidization route. Films were first cast on a glass substrate and then allowed to proceed through a thermal cycle with temperatures ranging from 100° C. to 350° C. The procedure entails heating the poly(amic acid) mixture to 100° C. and holding for one hour, heating from 100° C. to 200° C. and holding for one hour, heating from 200° C. to 300° C. and holding for one hour and slow cooling to room temperature from 300° C.

The PI films, pressed between two alumina plates, were heat-treated under a 3-sccm argon gas flow at 1000° C. This occurred in three steps: from room temperature to 600° C. in 1 h, from 600 to 1,000° C. in 1.3 h, and 1,000° C. maintained for 1 h.

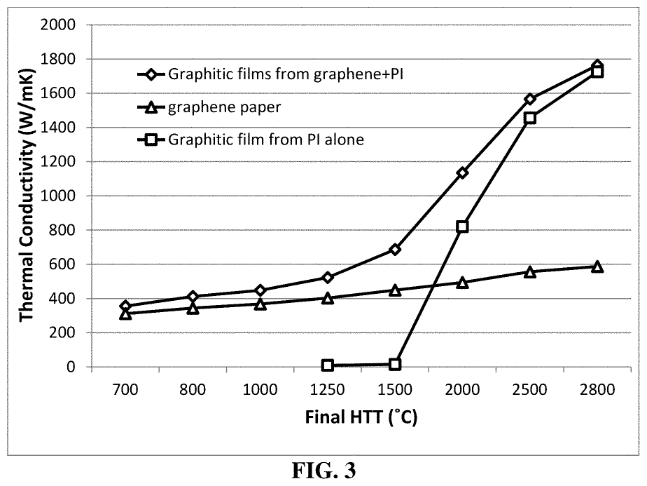

The thermal conductivity values of a series of graphitic films derived from graphene-PI films (66% graphene+34% PI), graphene paper alone, and PI film alone each prepared at various final heat treatment temperatures were measured and summarized in FIG. 3.

1. A battery cooling and fire protection system, comprising:
a) a plurality of battery cells, wherein at least one of the battery cells comprises an anode, a cathode, an electrolyte disposed between the anode and the cathode, a protective housing that at least partially encloses the anode, the cathode and the electrolyte, and at least one heat spreader element disposed at least partially inside the protective housing; and
b) a case which holds the plurality of battery cells and a cooling liquid which comprises a fire protection or fire suppression substance, wherein the battery cells are at least partially submerged in the cooling liquid which is in thermal communication with the heat spreader element and transports heat away from the battery cells through the heat spreader element to the cooling liquid.

2. The system of claim 1, wherein the fire protection or fire suppression substance comprises a fluorinated organic compound.

3. The system of claim 2, wherein the fluorinated organic compound is selected from the group consisting of hydrochlorofluorocarbons, hydrofluorocarbons, perfluorocarbons, perfluorinated amines, partially fluorinated ethers, hydrofluoroethers, hydrofluorolefins, fluorinated ketones, and combinations thereof.

4. The system of claim 2, wherein the fluorinated organic compound is selected from a fluorinated ketone CₙF₂ₙO (6<n<20), heptafluoropropane, or a combination thereof.

5. The system of claim 1, wherein the cooling liquid comprises a dielectric liquid having the fire protection or fire suppression substance dissolved or dispersed in the dielectric liquid.

6. The system of claim 5, wherein the fire protection or fire suppression substance comprises ABC dry chemicals designed for extinguishing class A, class B, and/or class C fires.

7. The system of claim 1, wherein the case has at least a first port and a second port configured to allow the cooling liquid to flow through the case with the battery cells being partially or fully submerged in the cooling liquid.

8. The system of claim 1, wherein the cooling liquid is in fluid communication with an external cooling device selected from a heat sink, a heat pipe, a vapor chamber, a stream of flowing fluid, a thermoelectric device, a heat exchanger, a radiator, or a combination thereof.

9. The system of claim 1, wherein the heat spreader element comprises a high thermal conductivity material having a thermal conductivity from 10 to 1,850 W/mK.

10. The system of claim 1, wherein the heat spreader element comprises a material selected from a graphene film, flexible graphite sheet, artificial graphite film, Ag, Ag, Cu, Al, brass, steel, Ti, Ni, Mg alloy sheet, silicon nitride, boron nitride, aluminum nitride, boron arsenide, a composite thereof, or a combination thereof.

11. The system of claim 10, wherein the graphene film contains a graphene selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

12. The system of claim 1, wherein the heat spreader element is in physical or thermal contact with the anode or the cathode and has a heat-spreading area at least 50% of a surface area of the anode or cathode.

13. The system of claim 10, wherein said graphene film has a thermal conductivity no less than 600 W/mK.

14. The system of claim 10, wherein said graphene film comprises a graphene material selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

15. The system of claim 1, wherein the heat spreader element is in a heat-spreading relation to the anode or the cathode and draws heat therefrom during an operation of the battery cells.

16. The system of claim 1, wherein the heat spreader element has a thickness from about 0.1 μm to about 1 mm.

17. The system of claim 1, wherein the battery has an anode terminal and a cathode terminal for operating the battery and the heat spreader element is in thermal contact with the anode terminal or the cathode terminal wherein the anode terminal or the cathode terminal is configured to spread heat to the cooling liquid.

18. The system of claim 1, wherein the heat spreader element is in thermal contact with the protective housing or a cap of the protective housing.

19. The system of claim 1, wherein the battery is a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, or supercapacitor.

20. A method of cooling and protecting a battery module or pack comprising a plurality of battery cells, said method comprising holding the plurality of battery cells and a cooling liquid in a case, wherein the plurality of battery cells are partially or fully submerged in the cooling liquid that comprises a fire protection or fire suppression substance and wherein the cooling liquid remains stationary residing in the case or is circulated in and out of the case to carry battery-generated heat away from the battery cells.

21-30. (canceled)
